(19) United States
(12) Patent Application Publication
(10) Pub. No.: US 2026/0348874 A1
(43) Pub. Date: Nov. 5, 2026

(54) SEMICONDUCTOR INSPECTION APPARATUS, SEMICONDUCTOR INSPECTION METHOD, AND METHOD OF MANUFACTURING SEMICONDUCTOR MODULE

(71) Applicant: Mitsubishi Electric Corporation, Tokyo (JP)

(72) Inventors: Hiroki KUROMATSU, Tokyo (JP); Osamu SUZUKI, Tokyo (JP); Hiroya YAMARIN, Tokyo (JP)

(73) Assignee: Mitsubishi Electric Corporation, Tokyo (JP)

(21) Appl. No.: 19/555,964

(22) Filed: Mar. 4, 2026

(30) Foreign Application Priority Data
May 1, 2025 (JP) 2025-076103

(51) Int. Cl. G01N 21/95; G01N 21/88

(52) U.S. Cl. CPC G01N 21/9505; G01N 21/8851

(57) ABSTRACT

An object of the present disclosure is to improve a failure detection rate in a semiconductor inspection. A semiconductor inspection apparatus includes an optical sensor which can be moved in a plurality of inspection positions on an arc-like route with an inspection stage located inside an arc. The semiconductor inspection apparatus includes a defect determination unit determining presence or absence of a defect of a semiconductor wafer based on brightness of reflected light which has been received. The defect determination unit determines that the semiconductor wafer includes a defect when the brightness of the reflected light is equal to or larger than a predetermined threshold value in one of the plurality of inspection positions, and determines that the semiconductor wafer does not include a defect when the brightness of the reflected light is smaller than the threshold value at all of the plurality of inspection positions.

### BACKGROUND

### Technical Field

The present disclosure relates to an appearance inspection on a semiconductor wafer, for example.

### Description of the Background Art

A semiconductor inspection apparatus inspecting an appearance of an inspection target object such as a semiconductor wafer or a semiconductor chip includes a light source irradiating the inspection target object with light and a camera detecting reflected light. Examples of documents indicating a conventional technique relating to a technique of the present disclosure include International Publication No. 2001/071323.

### SUMMARY

Since positions of a light source of a semiconductor inspection apparatus and a camera with respect to an inspection target object are generally fixed, there is a problem that illuminance of light received by the camera decreases depending on a shape of a defect, shortage of contrast in the defect occurs, and a failure detection rate decreases.

An object of the present disclosure is to improve a failure detection rate in a semiconductor inspection.

A semiconductor inspection apparatus according to the present disclosure includes an inspection stage, at least one optical sensor, and a defect determination unit. The inspection stage includes a front surface to which an inspection target object including a semiconductor wafer or a semiconductor chip is mounted. The at least one optical sensor can be moved in a plurality of inspection positions on an arc-like route with the inspection stage located inside an arc. The at least one optical sensor includes a light source and a camera. The light source irradiates an inspection target object mounted to the inspection stage with light. The camera receives reflected light reflected by the inspection target object upon receiving the light from the light source. The defect determination unit determines presence or absence of a defect of the inspection target object based on brightness of the reflected light. The defect determination unit determines that the inspection target object includes a defect when the brightness of the reflected light is equal to or larger than a predetermined threshold value in one of the plurality of inspection positions, and determines that the inspection target object does not include a defect when the brightness of the reflected light is smaller than the threshold value at all of the plurality of inspection positions.

According to the semiconductor inspection apparatus in the present disclosure, light can be emitted from an appropriate position in accordance with a shape of a defect by irradiating an inspection target object with the light from a plurality of directions, and a failure detection rate is improved.
These and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a diagram illustrating a configuration of a semiconductor inspection apparatus according to an embodiment 1.

FIG. 2 is a flow chart illustrating an operation of the semiconductor inspection apparatus according to the embodiment 1.

FIG. 3 is a diagram illustrating an arrangement of the semiconductor inspection apparatus according to the embodiment 1 in a case where a bright image is obtained.

FIG. 4 is a diagram illustrating an arrangement of the semiconductor inspection apparatus according to the embodiment 1 in a case where a dark image is obtained.

FIG. 5 is a diagram illustrating an inclination angle θ of an optical sensor, a length L of a defect surface, and a depth H of a defect.

FIG. 6 is a diagram illustrating a semiconductor inspection apparatus according to an embodiment 2 inspecting a front surface of a semiconductor wafer.

FIG. 7 is a diagram of the semiconductor inspection apparatus according to the embodiment 2 inspecting a back surface of the semiconductor wafer.

FIG. 8 is a diagram illustrating a configuration of a semiconductor inspection apparatus according to an embodiment 3.

FIG. 9 is a diagram of a semiconductor inspection apparatus according to an embodiment 4 detecting a downward warpage of the semiconductor wafer.

FIG. 10 is a diagram of the semiconductor inspection apparatus according to the embodiment 4 detecting an upward warpage of the semiconductor wafer.

FIG. 11 is a diagram of the semiconductor inspection apparatus according to the embodiment 4 suppressing a warpage of the semiconductor wafer.

FIG. 12 is a diagram illustrating occurrence of bulge in a back surface of a thin semiconductor wafer.

FIG. 13 is a diagram illustrating a configuration of a semiconductor inspection apparatus according to an embodiment 5.

FIG. 14 is a diagram illustrating a hardware configuration of a sensor controller and a pressure controller.

FIG. 15 is a diagram illustrating a hardware configuration of the sensor controller and the pressure controller.

### DESCRIPTION OF THE PREFERRED EMBODIMENTS

### A. Embodiment 1

### <A-1. Configuration>

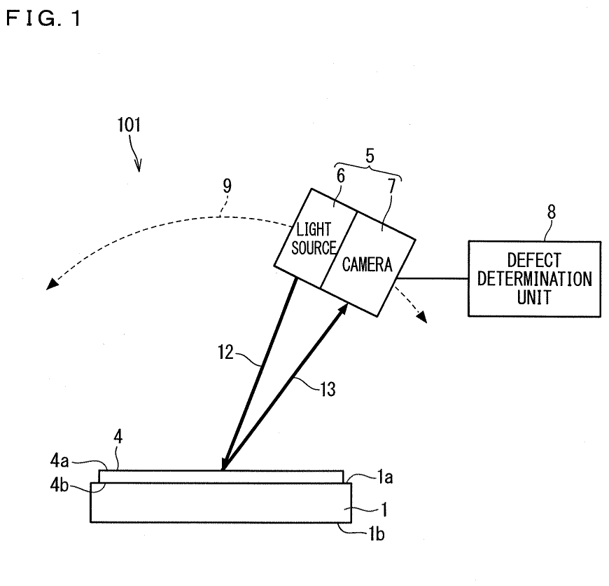

FIG. 1 is a diagram illustrating a configuration of a semiconductor inspection apparatus 101 according to an embodiment 1. The semiconductor inspection apparatus 101 includes an inspection stage 1, an optical sensor 5, and a defect determination unit 8. The inspection stage 1 includes a front surface 1a and a back surface 1b on a side opposite to the front surface 1a. A semiconductor wafer 4 is mounted to the front surface 1a of the inspection stage 1. Herein, the semiconductor wafer 4 is an example of an inspection target object on which the semiconductor inspection apparatus 101 inspects presence or absence of a defect. The inspection target object may be a semiconductor chip.

The semiconductor wafer 4 includes a front surface 4a and a back surface 4b on a side opposite to the front surface 4a. The semiconductor wafer 4 is mounted to the inspection stage 1 so that the back surface 4b thereof has contact with the front surface 1a of the inspection stage 1. The front surface 4a of the semiconductor wafer 4 faces the optical sensor 5 while the semiconductor wafer 4 is mounted to the inspection stage 1.

The optical sensor 5 can be moved on an arc-like route 9 over the semiconductor wafer 4 mounted to the inspection stage 1. The arc-like route 9 is an arc-like route with the inspection stage 1 located inside an arc. More preferably, the arc-like route 9 is an arc-like route centering around an inspection region in the semiconductor wafer 4 mounted to the inspection stage 1.

The optical sensor 5 includes a light source 6 and a camera 7. The light source 6 irradiates the inspection region in the semiconductor wafer 4 mounted to the inspection stage 1 with light. The light emitted from the light source 6 is reflected by the inspection region, and the camera 7 receives the reflected light. A position on the arc-like route 9 of the optical sensor 5 on which irradiation from the light source 6 and light reception by the camera 7 are performed is referred to as an inspection position. The arc-like route 9 includes a plurality of inspection positions. That is to say, the optical sensor 5 can emit and receive the light at the plurality of inspection positions on the arc-like route 9.

Information of the reflected light received by the camera 7 is transmitted to the defect determination unit 8. The defect determination unit 8 determines presence or absence of a defect in the inspection region based on brightness of the reflected light.

FIG. 1 illustrates the light source 6 and the camera 7 as an integrated configuration. However, the light source 6 and the camera 7 may be made as different housings as long as they can be synchronously moved on the arc-like route 9.

### <A-2. Operation>

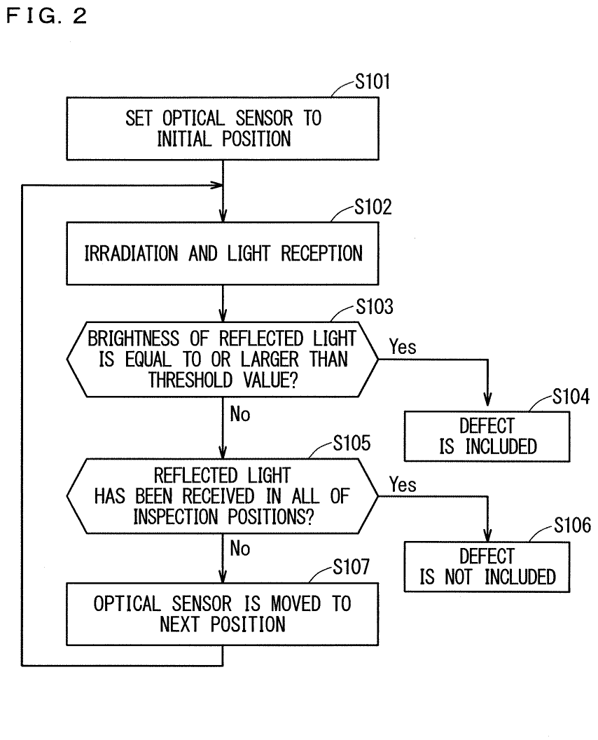

FIG. 2 is a flow chart illustrating an inspection process in the semiconductor inspection apparatus 101. The semiconductor inspection apparatus 101 performs the inspection process illustrated in FIG. 2 on each inspection region in the semiconductor wafer 4. The inspection region indicates a region in the semiconductor wafer 4 which the light source 6 can irradiate with the light at one time. The front surface 4a of the semiconductor wafer 4 is sectioned into a plurality of inspection regions, and inspection of a defect is performed on each inspection region.

In Step S101, firstly, the defect determination unit 8 sets the optical sensor 5 to an initial position on the arc-like route 9.

Next, in Step S102, the light source 6 irradiates the inspection region with the light, and the camera 7 receives the reflected light from the inspection region.

Subsequently, in Step S103, the defect determination unit 8 determines whether or not brightness of the reflected light received by the camera 7 is equal to or larger than a predetermined threshold value. When the brightness of the reflected light is equal to or larger than the threshold value in Step S103, the defect determination unit 8 determines that the inspection region includes a defect in Step S104.

When the brightness of the reflected light is smaller than the threshold value in Step S103, the defect determination unit 8 determines whether or not the optical sensor 5 has received the reflected light at all of the inspection positions on the arc-like route 9 in Step S105. When the optical sensor 5 has received the reflected light at all of the inspection positions on the arc-like route in Step S105, the defect determination unit 8 determines that the inspection region does not include a defect in Step S106.

When the optical sensor 5 has not received the reflected light at all of the inspection positions on the arc-like route 9 in Step S105, the defect determination unit 8 moves the optical sensor 5 to a next inspection position on the arc-like route 9 in Step S107.

After Step S107, the process of the semiconductor inspection apparatus 101 returns to Step S102. In Step S102, the light source 6 emits the light and the camera 7 receives the light at a new inspection position. The defect determination unit 8 compares brightness of reflected light at the new inspection position with a threshold value, and when the brightness of the reflected light is equal to or larger than the threshold value, the defect determination unit 8 determines that the inspection region includes a defect. In this manner, the defect determination unit 8 repetitively updates the inspection position of the optical sensor 5 until the reflected light having the brightness equal to or larger than the threshold value is obtained. When the defect determination unit 8 confirms that the brightness of the reflected light is smaller than the threshold value at all of the inspection positions, the defect determination unit 8 determines that the inspection region does not include a defect.

### <A-3. Effect>

The semiconductor inspection apparatus 101 according to the embodiment 1 includes an inspection stage including a front surface to which an inspection target object including a semiconductor wafer or a semiconductor chip are mounted and at least one optical sensor which can be moved on a plurality of inspection positions on an arc-like route with the inspection stage located inside an arc. At least one optical sensor includes a light source irradiating the inspection target object mounted to the inspection stage with light and a camera receiving reflected light reflected by the inspection target object upon receiving the light from the light source. The semiconductor inspection apparatus 101 further includes a defect determination unit determining presence or absence of a defect of the inspection target object based on brightness of the reflected light. The defect determination unit determines that the inspection target object includes a defect when the brightness of the reflected light is equal to or larger than a predetermined threshold value at one of the plurality of inspection positions, and determines that the inspection target object does not include a defect when the brightness of the reflected light is smaller than the threshold value at all of the plurality of inspection positions.

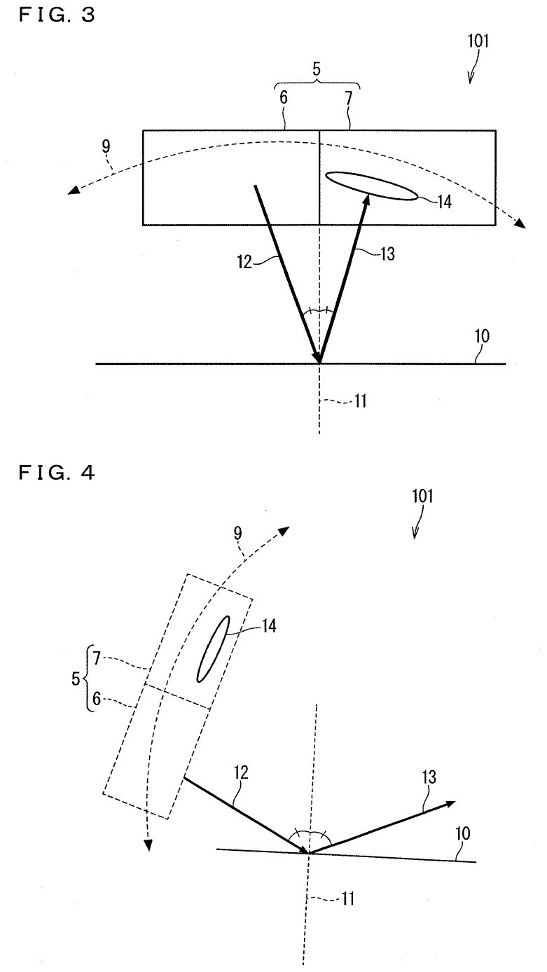

When the inspection region includes the defect, a direction of the reflected light is changed by an angle between a defect surface and the optical sensor 5; thus, the brightness of the reflected light received by the camera 7 is also changed. FIG. 3 illustrates the optical sensor 5 directed to a direction of a normal line 11 of a defect surface 10. In such a case, light 12 is emitted from the light source 6, and reflected light 13 reflected by the defect surface 10 enters a lens 14 of the camera 7. Accordingly, brightness of the reflected light 13 detected by the camera 7 is equal to or larger than a predetermined threshold value.

FIG. 4 illustrates the optical sensor 5 directed to a direction significantly different from the direction of the normal line 11 of the defect surface 10. In such a case, light 12 is emitted from the light source 6, and the reflected light 13 reflected by the defect surface 10 does not enter the lens 14 of the camera 7. Accordingly, brightness of the reflected light 13 detected by the camera 7 is smaller than the threshold value.

According to the semiconductor inspection apparatus 101, inspection is performed while the optical sensor 5 is moved on the arc-like route 9. Thus, when a surface in the inspection region includes a defect, an inspection position of the optical sensor 5 having high brightness of the reflected light illustrated in FIG. 3 can be found. Accordingly, a defect can be detected with high contrast from an image taken by the camera 7 at the inspection position of the optical sensor 5 having the high brightness of the reflected light.

The defect determination unit 8 can also measure a depth of the defect from the image taken by the camera 7 at the inspection position of the optical sensor 5 having the high brightness of the reflected light.

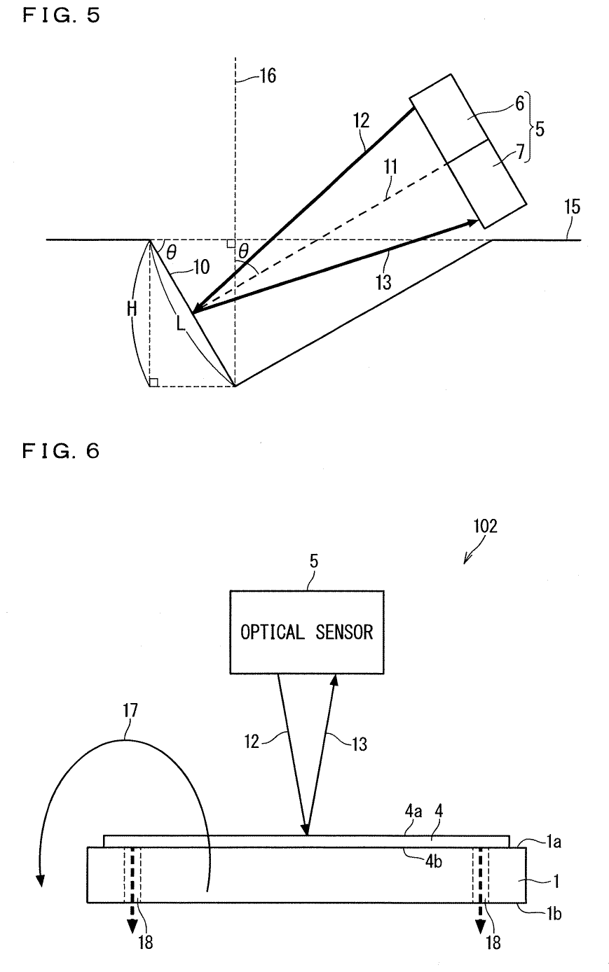

FIG. 5 illustrates the optical sensor 5 receiving the reflected light 13 on the defect surface 10 in the inspection region. As illustrated in FIG. 5, when the optical sensor 5 is directed to the normal line direction of the defect surface 10, the reflected light 13 on the defect surface 10 can be received with high brightness. In this case, when an inclination angle of the optical sensor 5 with respect to the normal line 16 of a wafer surface 15 is θ and a length of the defect surface 10 is L, a depth H of the defect is expressed as Lsin (θ). Accordingly, the defect determination unit 8 can calculate the depth H of the defect from the inclination angle θ of the optical sensor 5 at which the brightness of the reflected light gets high and the length L of the defect surface 10 obtained from the taken image at that time. In the above description, the position of the optical sensor 5 is located on an arc centering around a point on the wafer surface 15.

In this manner, according to the semiconductor inspection method in the present embodiment, the semiconductor wafer 4 is mounted to the inspection stage 1, and the optical sensor 5 which can be moved in the plurality of inspection positions on the arc-like route 9 with the inspection stage 1 located inside the arc is disposed at an optical inspection position in the plurality of inspection positions to inspect the semiconductor wafer 4. The inspection includes irradiation of the semiconductor wafer 4 with the light 12 by the light source 6 included in the optical sensor 5 and light reception of the reflected light 13 reflected by the semiconductor wafer 4 upon receiving the light 12 from the light source 6 by the camera 7 included in the optical sensor 5. When the brightness of the reflected light 13 which has been received is equal to or larger than the predetermined threshold value, it is determined that the semiconductor wafer 4 includes the defect, and when the brightness of the reflected light 13 which has been received is smaller than the threshold value, the inspection position of the optical sensor 5 is updated and inspection is performed.

According to the semiconductor module manufacturing method in the present embodiment, presence or absence of the defect of the semiconductor wafer 4 is inspected using the semiconductor inspection apparatus 101, that is to say, the semiconductor inspection method according to the present embodiment, and the semiconductor module is assembled using the inspected semiconductor wafer 4. Since the semiconductor module is assembled using the semiconductor wafer 4 with no defect, which is determined by the semiconductor inspection apparatus 101, a failure rate of the semiconductor module can be reduced.

### B. Embodiment 2

### <B-1. Configuration>

FIG. 6 is a diagram illustrating a semiconductor inspection apparatus 102 according to an embodiment 2 inspecting the front surface 4a of the semiconductor wafer 4. In the semiconductor inspection apparatus 102, the inspection stage 1 is made up of a transparent material such as quartz. The inspection stage 1 includes a vacuum suction hole 18 in an outer surrounding part thereof, and can vacuum suck a rim part provided to an outer surrounding of the semiconductor wafer 4 through the vacuum suction hole 18. The inspection stage 1 can be rotated around an axis along a surface direction of the front surface 4a while sucking the semiconductor wafer 4. That is to say, the inspection stage 1 has a reversal mechanism. The other configuration of the semiconductor inspection apparatus 102 is similar to that of the semiconductor inspection apparatus 101 according to the embodiment 1.

The semiconductor inspection apparatus 102 inspects the front surface 4a of the semiconductor wafer 4 in the manner similar to the semiconductor inspection apparatus 101 according to the embodiment 1 while the inspection stage 1 vacuum sucks the semiconductor wafer 4. The optical sensor 5 makes the light 12 enter the front surface 1a, and receives the reflected light 13. When the inspection on the front surface 4a is completed, as shown by an arrow 17 in FIG. 6, the inspection stage 1 is rotated so that the front surface 1a and the back surface 1b are reversed.

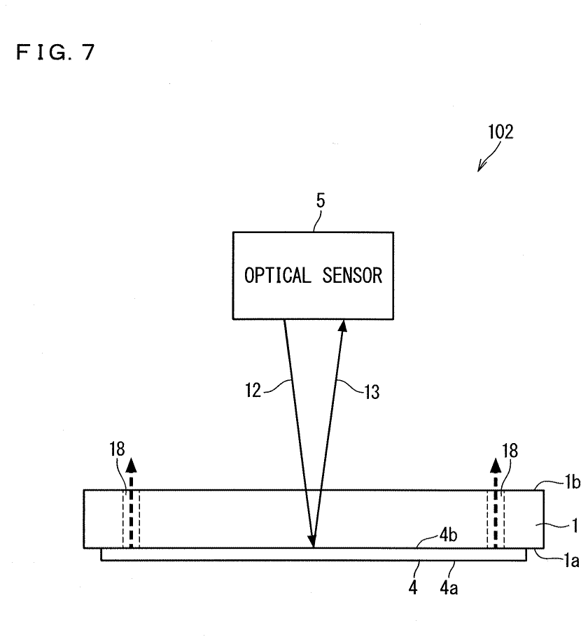

Accordingly, as illustrated in FIG. 7, the back surface 1b of the inspection stage 1 faces the optical sensor 5. Since the inspection stage 1 is made up of the transparent material, the optical sensor 5 can inspect the back surface 4b of the semiconductor wafer 4 through the inspection stage 1 in the manner similar to the inspection on the front surface 4a. The optical sensor 5 makes the light 12 enter the back surface 4a of the semiconductor wafer 4, and receives the reflected light 13.

In FIG. 6 and FIG. 7, illustration of the defect determination unit 8 is omitted.

### <B-2. Effect>

In the semiconductor inspection apparatus 102, the inspection stage 1 is made up of the transparent material, and can be rotated around the axis along the surface direction of the front surface 4a while sucking the semiconductor wafer 4. Thus, the semiconductor inspection apparatus 102 can inspect the back surface 4b by reversing the inspection stage 1 after inspecting the front surface 4a. Accordingly, both surfaces of the semiconductor wafer 4 can be inspected. Since both surfaces can be continuously inspected without detaching the semiconductor wafer 4 from the inspection stage 1, a speed of the inspection process is increased. Since a mechanism for reversing the semiconductor wafer 4 different from the inspection stage 1 is unnecessary, the semiconductor inspection apparatus 102 can be downsized.

### C. Embodiment 3

### <C-1. Configuration>

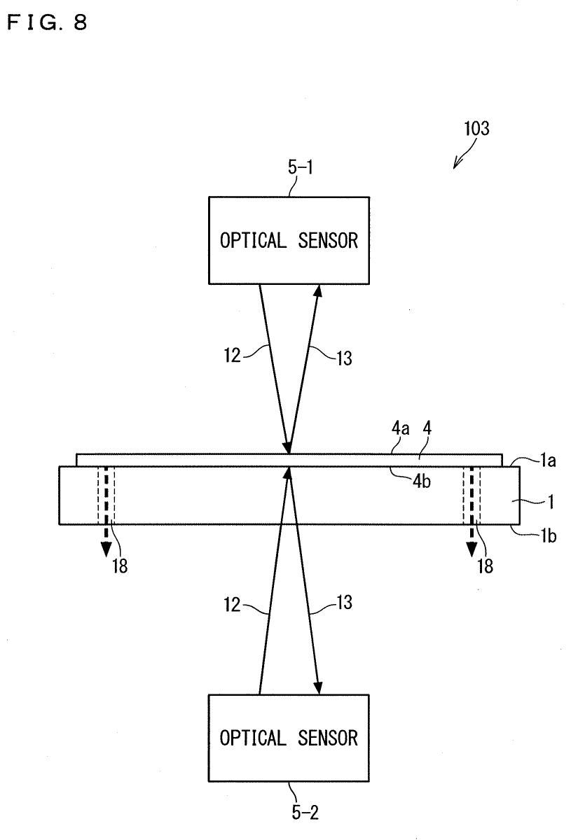

FIG. 8 is a diagram illustrating a configuration of a semiconductor inspection apparatus 103 according to an embodiment 3. The semiconductor inspection apparatus 103 is different from the semiconductor inspection apparatus 102 according to the embodiment 2 only in that the semiconductor inspection apparatus 103 includes two optical sensors 5-1 and 5-2 in place of the optical sensor 5. A configuration of the optical sensors 5-1 and 5-2 is similar to that of the optical sensor 5, and each of the optical sensors 5-1 and 5-2 includes the light source 6 and the camera 7. The optical sensor 5-1 and the optical sensor 5-2 are also referred to as a first optical sensor and a second optical sensor, respectively.

The optical sensor 5-1 is provided to a side of the front surface 1a of the inspection stage 1, irradiates the front surface 4a of the semiconductor wafer 4 with the light 12, and receives the reflected light 13.

The optical sensor 5-2 is provided to a side of the back surface 1b of the inspection stage 1, irradiates the back surface 4b of the semiconductor wafer 4 with the light 12 through the inspection stage 1, and receives the reflected light 13.

In FIG. 8, illustration of the defect determination unit 8 is omitted.

### <C-2. Effect>

In the semiconductor inspection apparatus 103, the inspection stage 1 is made up of a transparent material, and at least one optical sensor includes the optical sensor 5-1 provided to the side of the front surface 1a of the inspection stage 1 and the optical sensor 5-2 provided to the side of the back surface 1b facing the front surface 1a of the inspection stage 1. In such a configuration, when the optical sensors 5-1 and 5-2 performs irradiation and light reception at the same time, the front surface 4a and the back surface 4b of the semiconductor wafer 4 can be inspected at the same time. Accordingly, an inspection speed is increased in the semiconductor inspection apparatus 103 compared with the semiconductor inspection apparatus 102 according to the embodiment 2. According to the semiconductor inspection apparatus 103, the reversal mechanism of the inspection stage 1 provided to the semiconductor inspection apparatus 102 according to the embodiment 2 is unnecessary.

### D. Embodiment 4

### <D-1. Configuration>

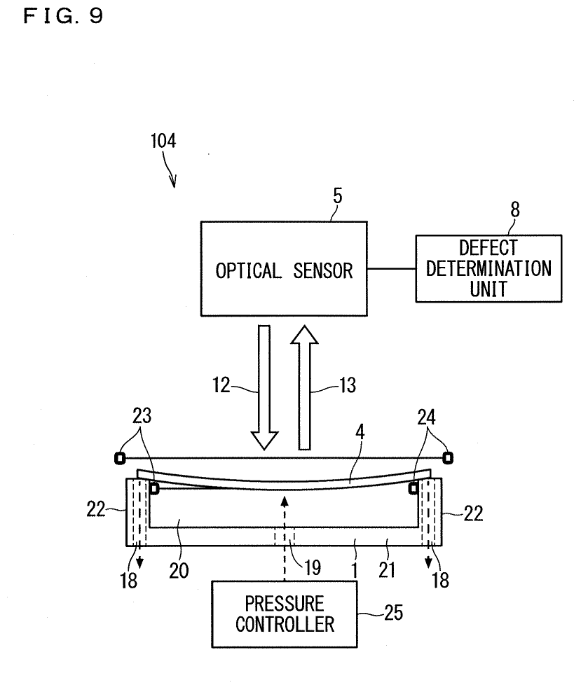

FIG. 9 is a diagram illustrating a configuration of a semiconductor inspection apparatus 104 according to an embodiment 4. In the semiconductor inspection apparatus 104, the inspection stage 1 includes a planar part 21 and an outer surrounding part 22 protruding from an outer surrounding of the planar part 21. At least one pressure adjustment hole 19 is provided to the planar part 21. The vacuum suction hole 18 sucking the rim part in the outer surrounding of the semiconductor wafer is provided to the outer surrounding part 22. Since the inspection stage 1 has such a shape, an inner space 20 surrounded by the inspection stage 1 and the semiconductor wafer 4 mounted to the inspection stage 1 is formed.

The semiconductor inspection apparatus 104 includes a warpage detection sensor detecting a warpage of the semiconductor wafer 4 mounted to the inspection stage 1. As illustrated in FIG. 9, for example, the warpage detection sensor includes a projector 23 disposed around the outer surrounding part 22 and a light receiver 24 provided on an opposite side of the semiconductor wafer 4 from the projector 23. Two sets of the projector 23 and the light receiver 24 are provided. An upper set is for detecting an upward warpage of the semiconductor wafer 4, and a lower set is for detecting a downward warpage of the semiconductor wafer 4.

FIG. 9 illustrates the semiconductor wafer 4 warped downward. In this case, laser light emitted from the projector 23 on the upper side is received by the light receiver 24 on the upper side. However, laser light emitted from the projector 23 on the lower side is blocked by the semiconductor wafer 4, thus is not received by the light receiver 24 on the lower side. Accordingly, the warpage detection sensor can detect the semiconductor wafer 4 warped downward.

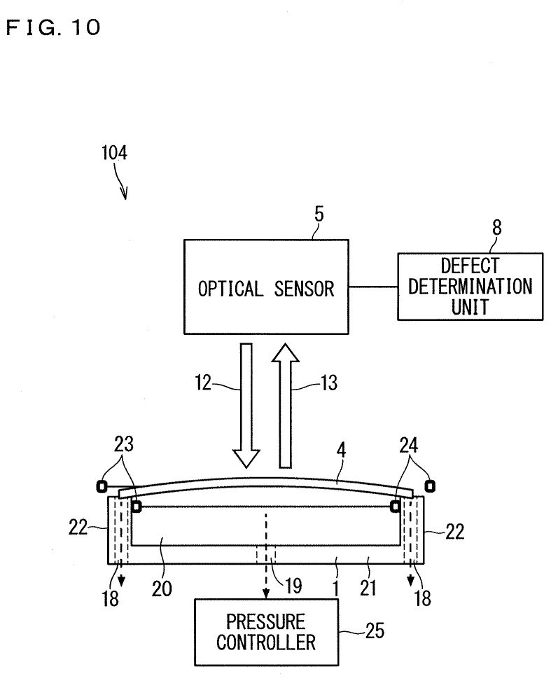

FIG. 10 illustrates the semiconductor wafer 4 warped upward. In this case, laser light emitted from the projector 23 on the lower side is received by the light receiver 24 on the lower side. However, laser light emitted from the projector 23 on the upper side is blocked by the semiconductor wafer 4, thus is not received by the light receiver 24 on the upper side. Accordingly, the warpage detection sensor can detect the semiconductor wafer 4 warped upward.

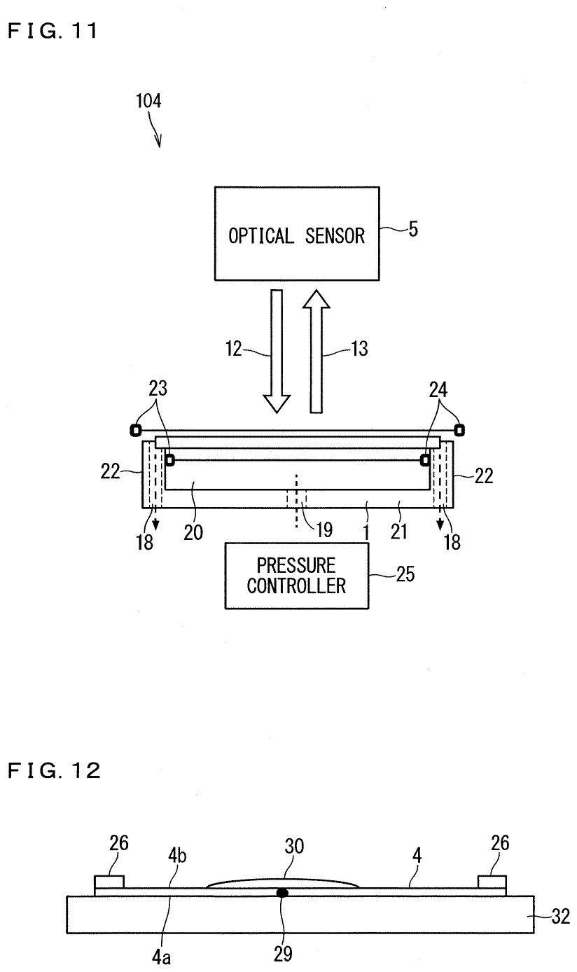

The semiconductor inspection apparatus 104 includes a pressure controller 25 controlling pressure in the inner space 20 surrounded by the inspection stage 1 and the semiconductor wafer 4 mounted to the inspection stage 1 through at least one pressure adjustment hole 19. The pressure controller 25 performs dry air pressurization on the inner space 20 when the semiconductor wafer 4 is warped downward, and performs dry air decompression on the inner space 20 when the semiconductor wafer 4 is warped upward based on a detection result of the warpage detection sensor. Accordingly, as illustrated in FIG. 11, the warpage of the semiconductor wafer can be reduced.

The projector 23 and the light receiver 24 illustrated in FIG. 9 to FIG. 11 are examples of the configuration of the warpage detection sensor. The optical sensor 5 may double as the warpage detection sensor.

### <D-2. Effect>

In the semiconductor inspection apparatus 104 according to the embodiment 4, the inspection stage 1 includes the planar part 21 to which at least one pressure adjustment hole 19 is provided and the outer surrounding part 22 protruding from the outer surrounding of the planar part 21 and including the vacuum suction hole 18 sucking the rim part in the outer surrounding of the semiconductor wafer 4. The semiconductor inspection apparatus 104 includes the warpage detection sensor detecting the warpage of the semiconductor wafer 4 and the pressure controller 25 controlling pressure in the inner space 20 surrounded by the inspection stage 1 and the semiconductor wafer 4 mounted to the inspection stage 1 through at least one pressure adjustment hole 19 based on the warpage state of the semiconductor wafer 4 detected by the warpage detection sensor. The semiconductor inspection apparatus 104 can reduce the warpage of the semiconductor wafer 4. Thus, when the inspection is performed after the warpage is reduced, deviation of a focus point of the light emitted to the semiconductor wafer 4 is resolved. Since a mapping operation for automatic focusing needs not be performed before the inspection to prevent the deviation of the focus point caused by the warpage of the semiconductor wafer 4, such a configuration leads to simplification of an inspection recipe and reduction of takt.

### <E. Embodiment 5

### <E-1. Configuration>

FIG. 12 illustrates a bulge 30 occurring in the semiconductor wafer 4. The extremely thin semiconductor wafer 4 has a rim mechanism in the outer surrounding for measures for warpage or increasing strength. That is to say, the semiconductor wafer 4 includes a planar part 28 and a rim part 26 protruding from an outer surrounding of the planar part 28.

Such a semiconductor wafer 4 is mounted on a processing stage 32 and processed. A convex minute foreign material 29 is formed in forming a surface pattern of the semiconductor wafer 4 in some cases. In such a case, when the back surface of the semiconductor wafer 4 is subsequently processed on the processing stage 32 and the semiconductor wafer 4 and the processing stage 32 are firmly attached to each other, local force from the minute foreign material 29 as a start point is applied to the semiconductor wafer 4, and the bulge 30 having a size 30 to 100 times larger than a size of the minute foreign material 29 occurs.

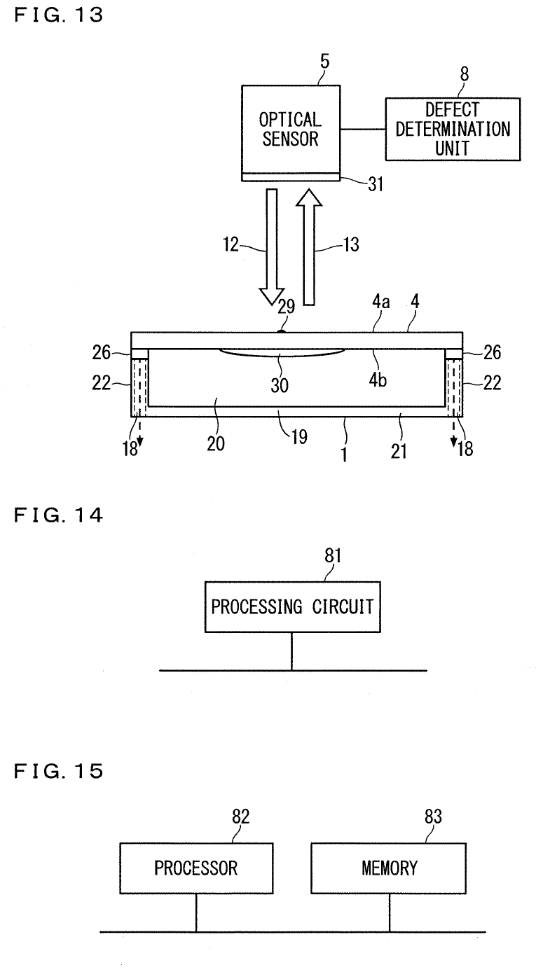

FIG. 13 shows a configuration of a semiconductor inspection apparatus 105 according to an embodiment 5. The semiconductor inspection apparatus 105 is different from the semiconductor inspection apparatus 101 according to the embodiment 1 only in that the optical sensor 5 includes a differential interference filter 31.

The differential interference filter 31 is provided to both the light source 6 and the camera 7 of the optical sensor 5. The inspection stage 1 has a shape similar to that according to the embodiment 4 including the planar part 21 and the outer surrounding part 22 protruding from the outer surrounding of the planar part 21 in FIG. 13, but may have a shape described in the embodiment 1.

Although the bulge 30 is particularly smooth, thus cannot be observed by a normal microscope, the optical sensor 5 according to the present embodiment can observe the bulge 30 through the differential interference filter 31.

The configuration that the optical sensor 5 includes the differential interference filter 31 can also be applied to any of the semiconductor inspection apparatuses 101 to 104 according to the embodiments 1 to 4.

### <E-2. Effect>

In the semiconductor inspection apparatus 105 according to the embodiment 5, the optical sensor 5 includes the differential interference filter 31. Thus, the bulge 30 can be detected by a wide-field shot, and the minute foreign material 29 having a size equal to or smaller than 10 μm can be thereby detected. Since the minute foreign material 29 is detected, the minute foreign material 29 slipping through a test process or a latent failure factor in an end user can be excluded. A focus point needs not be set by reason that the wide-field shot is applied, and the inspection can be performed at a high speed. Detection of a false defect is significantly reduced, and a capacity of a recording medium is also reduced.

### <F. Hardware Configuration>

The defect determination unit 8 in the semiconductor inspection apparatuses 101 to 105 described above is achieved by a processing circuit 81 illustrated in FIG. 14. That is to say, the processing circuit 81 includes the defect determination unit 8. Dedicated hardware may be applied to the processing circuit 81, or a processor executing a program stored in a memory may also be applied. The processor is a central processing unit, a processing device, an arithmetic device, a microprocessor, a microcomputer, or a digital signal processor (DSP), for example.

When the processing circuit 81 is the dedicated hardware, a single circuit, a complex circuit, a programmed processor, a parallel-programmed processor, an application specific integrated circuit (ASIC), a field-programmable gate array (FPGA), or a combination of them, for example, falls under the processing circuit 81.

When the processing circuit 81 is the processor, the functions of the defect determination unit 8 are achieved by a combination with software etc. (software, firmware, or software and firmware). The software etc. is described as a program and is stored in a memory. As illustrated in FIG. 15, a processor 82 applied to the processing circuit 81 reads out and executes a program stored in a memory 83, thereby achieving the function of each unit. That is to say, the semiconductor inspection apparatuses 101 to 105 include the memory 83 to store the program to resultingly execute, at a time of being executed by the processing circuit 81, the function of the defect determination unit 8. In other words, this program is also deemed to make a computer execute a procedure or a method of the defect determination unit 8. Herein, the memory 83 may be a non-volatile or volatile semiconductor memory such as a RAM (Random Access Memory), a ROM (Read Only Memory), a flash memory, an EPROM (Erasable Programmable Read Only Memory), or an EEPROM (Electrically Erasable Programmable Read Only Memory), an HDD (Hard Disk Drive), a magnetic disc, a flexible disc, an optical disc, a compact disc, a mini disc, a DVD (Digital Versatile Disc), or a drive device of them, or any storage medium which is to be used in the future, for example.

While the embodiments etc. have been shown and described in detail, the above embodiments are not restrictive. Various modifications and replacements can be added to the above embodiments without departing from the scope of claims.

What is claimed is:

1. A semiconductor inspection apparatus, comprising:
an inspection stage including a front surface to which an inspection target object including a semiconductor wafer or a semiconductor chip is mounted;
at least one optical sensor which can be moved in a plurality of inspection positions on an arc-like route with the inspection stage located inside an arc;
a processor to execute a program; and
a memory to store the program, wherein
the at least one optical sensor further includes:
a light source irradiating an inspection target object mounted to the inspection stage with light; and
a camera receiving reflected light reflected by the inspection target object upon receiving the light from the light source, wherein
the program, when executed by the processor, performs processes of:
determining presence or absence of a defect of the inspection target object based on brightness of the reflected light; and
determining that the inspection target object includes a defect when brightness of the reflected light is equal to or larger than a predetermined threshold value at one of the plurality of inspection positions, and determining that the inspection target object does not include a defect when the brightness of the reflected light is smaller than the threshold value at all of the plurality of inspection positions.

2. The semiconductor inspection apparatus according to claim 1, wherein
the inspection stage is made up of a transparent material, and can be rotated around an axis along a surface direction of the front surface while sucking the inspection target object.

3. The semiconductor inspection apparatus according to claim 1, wherein
the inspection stage is made up of a transparent material,
the at least one optical sensor includes:
a first optical sensor provided to a side of the front surface of the inspection stage; and
a second optical sensor provided to a side of a back surface facing the front surface of the inspection stage.

4. The semiconductor inspection apparatus according to claim 1, wherein
the inspection stage includes:
a planar part to which at least one pressure adjustment hole is provided; and
an outer surrounding part protruding from an outer surrounding of the planar part and including a suction hole sucking a rim part in an outer surrounding of the inspection target object,
the semiconductor inspection apparatus further includes:
a warpage detection sensor detecting a warpage of the inspectiontarget object; and
a pressure controller controlling pressure in an inner space surrounded by the inspection stage and the inspection target object mounted to the inspection stage through the at least one pressure adjustment hole based on a warpage state of the inspection target object detected by the warpage detection sensor.

5. The semiconductor inspection apparatus according to claim 1, wherein
the at least one optical sensor includes a differential interference filter.

6. A semiconductor inspection method, comprising:
mounting an inspection target object including a semiconductor wafer or a semiconductor chip to an inspection stage; and
locating at least one optical sensor which can be moved in a plurality of inspection positions on an arc-like route with the inspection stage located inside an arc in an arbitrarily selected inspection position in the plurality of inspection positions and inspecting the inspection target object,
the inspection includes:
irradiation of the inspection target object with light by a light source included in the at least one optical sensor; and
reception of reflected light reflected by the inspection target object by a camera included in the at least one optical sensor upon receiving light from the light source,
it is determined that the inspection target object includes a defect when brightness of the reflected light is equal to or larger than a predetermined threshold value, and
an inspection position of the at least one optical sensor is updated and the inspection is performed when brightness of the reflected light is smaller than the threshold value.

7. A method of manufacturing a semiconductor module, comprising:
inspecting presence or absence of a defect of an inspection target object using the semiconductor inspection method according to claim 6, and
assembling a semiconductor module using the inspection target object which has been inspected.
